(19) United States
(12) Patent Application Publication
(10) Pub. No.: US 2020/0353546 A1
(43) Pub. Date: Nov. 12, 2020

(54) JIG SAW WITH CLAMPING MECHANISM

(71) Applicant: TECHTRONIC CORDLESS GP, Anderson, SC (US)

(72) Inventors: Lei HU, Dongguan (CN); Xiao Ping QIU, Dongguan (CN); Ji Zhou YAN, Dongguan (CN)

(21) Appl. No.: 16/867,633

(22) Filed: May 6, 2020

(30) Foreign Application Priority Data
May 7, 2019 (CN) 201920648981.9

(51) Int. Cl. B23D 51/16; B23D 61/12; B23D 49/00

(52) U.S. Cl. CPC B23D 51/166; B23D 49/007; B23D 61/12

(57) ABSTRACT

A jig saw including a clamping mechanism for removably clamping a saw blade and a driving mechanism. The clamping mechanism includes an actuating member and a clamping mechanism, the actuating member is configured to rotate about a first axis, thereby driving the clamping mechanism to achieve locking or unlocking of the saw blade. The actuating member includes an inclined surface extending in a rotation direction of the actuating member. The inclined surface cooperates with the clamping mechanism thereby to drive the clamping mechanism when the actuating member rotates. Since the clamping mechanism of the jig saw uses a clamping mechanism to apply pressure to the saw blade from the side, thereby abutting and fixing it on the main body, such a clamping mechanism therefore can be applied to different types of saw blades, regardless of the shape of the end faces of their clamping ends (e.g., V-shaped or U-shaped).

### TECHNICAL FIELD

The application relates to a jig saw, and more specifically, to a clamping mechanism for clamping a saw blade in a jig saw.

### BACKGROUND

Jig saws are widely used for the cutting of various board materials such as wood and metal, and are suitable for cutting curved shapes on these boards. The working principle of the jig saw is that rotation of the motor drives the saw blade to reciprocate through a conversion mechanism to perform cutting. Since the saw blade is easily worn after a large number of cutting operations, the saw blade clamping mechanism of the jig saw is usually designed to be able to clamp or unlock the saw blade by human hands, so that the user can replace the worn saw blade.

However, existing jig saw clamping mechanisms have many unsatisfactory features. For example, the clamping mechanism of many jig saws can only be applied to saw blades with specific shapes, such as T-shank saw blades with T-shaped ends or T-shank saw blades with U-shaped ends, but is not compatible with both types of saw blades. Such designs result in limitations on the types of saw blades that can be used with jig saws, which is not convenient for the user. In addition, many clamping mechanisms require the user to perform complicated operations to lock or unlock the saw blade, or require a great deal of effort to use, causing inconvenience to the user.

### SUMMARY

Therefore, the present application provides a jig saw including a clamping mechanism for removably clamping a saw blade and a driving mechanism. The clamping mechanism is connected to the driving mechanism. The clamping mechanism includes an actuating member and a clamping mechanism, where the actuating member is configured to rotate about a first axis, thereby driving the clamping mechanism to achieve locking or unlocking of the saw blade. The first axis is not parallel to the thickness direction of the saw blade in the installation position. The actuating member includes an inclined surface extending in a rotation direction of the actuating member. The inclined surface cooperates with the clamping mechanism thereby to drive the clamping mechanism when the actuating member rotates.

Preferably, the first axis is substantially parallel to a length direction of the saw blade in the installation position.

More preferably, the clamping mechanism further includes an intermediate piece. The clamping mechanism is movably connected to the intermediate piece, and the intermediate piece causes the clamping mechanism to generate a movement along the first axis and a movement along a second axis at the same time when the actuating member rotates, thereby achieving the locking and unlocking of the saw blade.

More preferably, the second axis is parallel to a width direction of the saw blade in the installation position.

Most preferably, the clamping mechanism is a locking pin, and the intermediate piece is a sleeve including a chute. The locking pin is received within the chute and is adapted to move along the chute. The orientation of the chute is neither parallel to the first axis nor perpendicular to the first axis.

In a variation of the preferred embodiment, the clamping mechanism further includes a first biasing member. The first biasing member is adapted to bias the actuating member along the rotation direction so that the clamping mechanism is in a locked position when no external force is applied.

In another variation of the preferred embodiment, the clamping mechanism further includes a second biasing member. The second biasing member is adapted to bias the clamping mechanism along the first axis direction so that the clamping mechanism is in the locked position when no external force is applied.

In another variation of the preferred embodiment, the clamping mechanism is suitable for both a U-shank saw blade and a T-shank saw blade.

The jig saw in the present application therefore overcomes the aforementioned technical problems. First, since the clamping mechanism of the jig saw uses a clamping mechanism to apply pressure to the saw blade from the side, thereby abutting and fixing it on the main body, such a clamping mechanism therefore can be applied to different types of saw blades, regardless of the shape of the end faces of their clamping ends (e.g., V-shaped or U-shaped). In contrast, since the saw blades have a generally thin sheet-like shape and a long strip shape, the clamping mechanism of the present application can firmly clamp these saw blades. This design greatly expands the types of saw blades that can be applied to the same jig saw, so that users can easily load different types of saw blades on the jig saw without replacing the jig saw or using external tools.

In addition, the actuating member of the clamping mechanism that can be operated by the user in the present application is designed in the form of a rotary lever, and such a rotating mechanism is converted into a linear movement of the clamping mechanism by a movement conversion mechanism. Such a rotary lever adopts a simple and reliable inclined surface design, which can convert the rotary movement of the actuating member into the linear movement of the locking pin, which not only is not prone to failure but also it amplifies the user's torque through the lever principle, so that it allows the user to operate the actuating member without requiring great effort. Such design makes it easier and faster for users to change the saw blade.

### BRIEF DESCRIPTION OF THE DRAWINGS

The performance and advantages of the present application can be further understood by referring to the rest of the description and the drawings; the same components in these drawings have the same reference numerals. In some cases, sub-tags are placed after a reference numeral and hyphen to indicate one of many similar components. When referring to a reference numeral without specifying an existing sub-tag, it means all these similar components.

FIG. 1 is a schematic diagram of an external appearance of a clamping mechanism in a jig saw according to an embodiment of the present application.

FIGS. 2a and 2b are partial enlarged views of the clamping mechanism in FIG. 1 at different angles, respectively.

FIG. 3 illustrates the positional relationship of the locking pin, the saw blade, and the strip spring directly contacting the locking pin in the clamping mechanism in FIG. 1, and other components are hidden at this time.

FIG. 4 illustrates the positional relationship of the locking pin, the intermediate piece, and the strip spring directly contacting the locking pin in the clamping mechanism in FIG. 1, and other components are hidden at this time.

### DETAILED DESCRIPTION

The embodiment of the present application uses a movement conversion mechanism to convert a user's rotation of the rotary lever into an inclined linear movement of the clamping mechanism, and such the inclined linear movement can clamp or unlock the saw blade. From the following description, other different benefits and advantages provided by various embodiments of the present application can be easily understood.

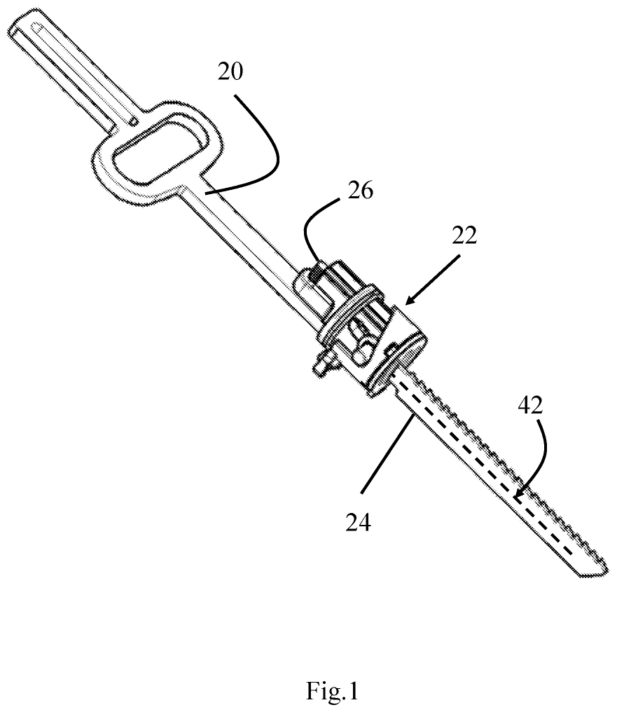

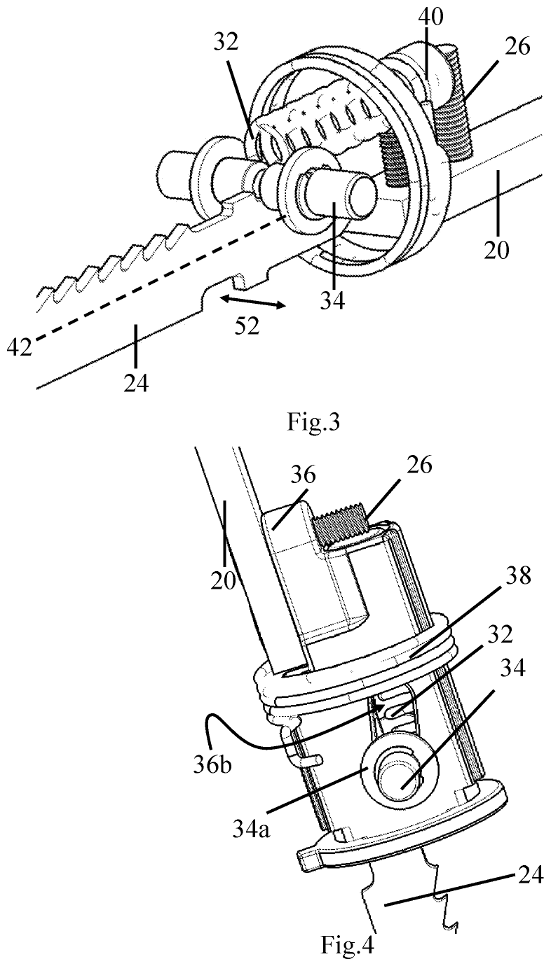

First, referring to FIG. 1, where a jig saw (with its entirety not shown) is disclosed in a first embodiment of the present application, which includes a clamping mechanism 22, a transmission rod 20 connected to the clamping mechanism 22, and the saw blade 24 which is removably mounted to the clamping mechanism 22. The saw blade 24 shown here is in an installation position, and at this time, the length direction of the saw blade 24 (also the length direction of the transmission rod 20) is substantially parallel to the first axis 42. It can be seen that the first axis 42 is not parallel to the thickness direction 52 of the saw blade 24 in the installation position (see the thickness direction 52 shown in FIG. 3). Here, the transmission rod 20 as a part of the driving mechanism of the jig saw is adapted to transmit a driving force generated by a motor (not shown) to the clamping mechanism 22 in the form of a reciprocating movement. The transmission rod 20 has a generally elongated shape well known to those skilled in the art, and its end is connected to the clamping mechanism 22 by a screw 26.

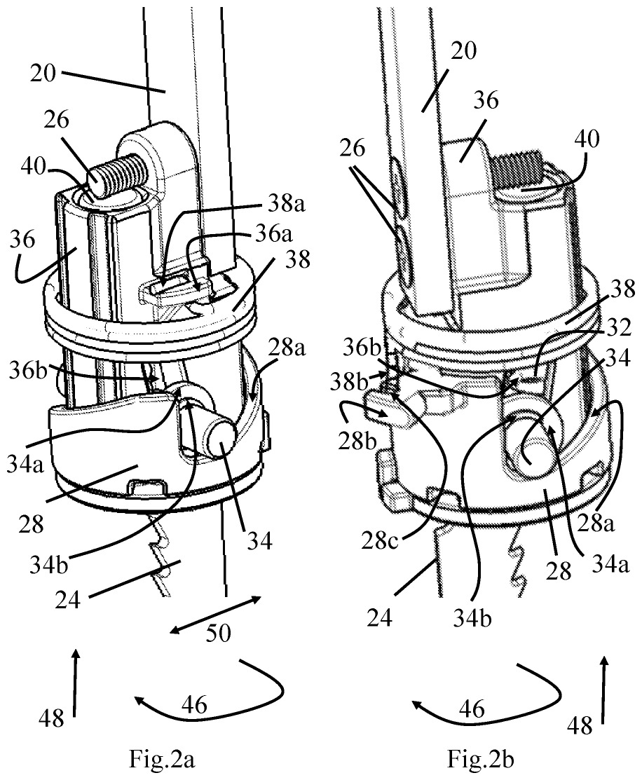

Referring to FIGS. 2a, 2b, 3 and 4, the clamping mechanism 22 specifically includes a rotary sleeve 28, a strip spring 32, a lock pin 34, an intermediate piece 36, a torsion spring 38, a spring seat 40, and the like. Among them, the intermediate piece 36, which is generally in the shape of a hollow cylinder, is fixedly connected to the transmission rod 20 by the two screws 26 described above. Therefore, the intermediate piece 36 is suitable for reciprocating movement along with the transmission rod 20. The two screws 26 are arranged along the length direction of the transmission rod 20. Outside the intermediate piece 36, a rotary sleeve 28 is sleeved. It should be noted that the rotary sleeve 28 can rotate relative to the intermediate piece 36, but when the intermediate piece 36 performs a reciprocating movement in the direction along the first axis 42, the rotary sleeve 28 moves along with it. The saw blade 24 is removably mounted to the lower end of the intermediate piece 36.

The length direction of the locking pin 34 is substantially perpendicular to the direction of the first axis 42. The locking pin 34 has a washer 34a and a snap spring 34b at its both ends, respectively, so that the locking pin 34 is received in the chute 36b of the intermediate piece 36 in a manner that it can move relative to the intermediate piece 36. The washer 34a and the snap spring 34b are located between the chute 36b and the rotary sleeve 28 as a spacer to prevent frictional interference of the movement of the locking pin 34 in the chute 36b. The above-mentioned rotary sleeve 28, the intermediate piece 36, and the locking pin 34 constitute a motion conversion mechanism of the clamping mechanism in this embodiment, which is adapted to convert the rotational movement around the first axis 42 into a linear movement along the direction of the first axis 42.

It should be noted that the intermediate piece 36 shown in FIGS. 2a and 2b is provided with a chute 36b at two positions 180 degrees apart on the peripheral surface thereof, both ends of the locking pin 34 are thus received in the two chutes 36b, respectively. The orientation of the chute 36b is neither parallel to nor perpendicular to the first axis 42, but must be in a certain angular relationship with the first axis. Specifically, the locking pin 34 can move relative to the intermediate piece 36 along a first axis 42 and along a second axis 50 parallel to the width direction of the saw blade 24 in the installation position (shown in FIG. 2a). This will be described in detail below. The intermediate piece 36 and the locking pin 34 play a clamping role together, because the locking pin 34 can abut against the saw blade 24 and press it against the inner wall of the intermediate piece 36 to achieve clamping of the saw blade 24. In the present embodiment, the locking pin 34 is also referred to a locking member.

In this embodiment, the rotary sleeve 28 is an actuating member contacted by a user's finger, and is adapted to be rotated by the user to achieve clamping or unlocking of the saw blade 24 by the clamping mechanism 22. As best shown in FIGS. 2a and 2b, the rotary sleeve 28 includes an inclined surface 28a extending in the circumferential direction (i.e., the direction of rotation). There is a gap between the two ends of the inclined surface in the direction along the first axis, and the gap is equivalent to the length of each of the chutes 36b described above. In addition, the rotary sleeve 28 also includes a handle 28b connected to the outer peripheral surface thereof and protruding substantially outward in the radial direction. The handle 28b is adapted to be touched and triggered by a user with a finger, thereby rotating the rotary sleeve 28. A recess 28c is formed in the handle 28b, and an end 38b of the torsion spring 38 is fixed in the recess 28c. In FIGS. 2a and 2b, if the rotary sleeve 28 rotates clockwise, the recess of the handle 28b drives the end 38b to rotate together, which will cause the torsion spring 38 to deform and thus generate a restoring force in the counterclockwise direction.

The other end 38a of the torsion spring 38 is also fixed to the intermediate piece 36 in a similar manner as described above. Specifically, the intermediate piece 36 is formed with a hook-shaped portion 36a protruding on the outer peripheral surface, so that the end 38a of the torsion spring 38 is fixed in the recess of the hook-shaped portion 36a. In this manner, the two ends of the torsion spring 38 are respectively fixed to a non-rotatable part (i.e., the intermediate piece 36) and a rotatable part (i.e., the rotary sleeve 28). Moreover, the position of the torsion spring 38 to the rotary sleeve 28 makes the latter stay in the rotating position shown in FIGS. 2a and 2b without external force interference, that is, the locking pin 34 is located at the end of the chute 36b closest to the saw blade 24 at this time. Due to the presence of the torsion spring 38, there is no linear displacement between the intermediate piece 36 and the rotary sleeve 28, but relative rotation can be allowed.

At the same time, the above-mentioned locking pin 34 is biased by the strip spring 32 in the direction along the first axis 42, so that the locking pin 34 stays in the locked position shown in FIGS. 2a and 2b without external force interference, that is, the locking pin 34 is located at the end of the chute 36b closest to the saw blade 24 at this time. The strip spring 32 is most clearly shown in FIG. 3, and the saw blade 24 shown here is a T-shank saw blade as an example. It can be seen that the locking pin 34 is now in the locked position, that is, the saw blade 24 cannot be removed from the jig saw at this time. At this time, the locking pin 34 is biased by the strip spring 32. One end of the strip spring 32 is adapted to contact and bias the locking pin 34, and the other end is fixed to a spring seat 40 mounted on the intermediate piece 36 (see FIGS. 2a and 2b). As shown in FIGS. 2a and 2b, the spring seat 40 is blocked by a screw 26 that fixes the transmission rod 20 and the intermediate piece 36 to prevent the spring seat 40 from moving relative to the intermediate piece 36.

Now look at the working principle of the jig saw clamping mechanism in the above-mentioned embodiment. Specifically, as described above, if there is no external force interference from the user, the clamping mechanism is in the clamped position by default, which is achieved by applying a biasing force to the locking pin 34 and the rotary sleeve 28 by the strip spring 32 and the torsion spring 38, respectively. If the user wants to remove the clamped saw blade 24, the user manually triggers the handle 28b on the rotary sleeve 28 in a clockwise direction shown by the arrow 46 in FIGS. 2a and 2b. The movement of the handle 28b causes the rotation sleeve 28 to rotate about the intermediate piece 36. However, since the end of the locking pin 34 is received on the inclined surface 28a of the rotary sleeve 28, the clockwise rotation of the rotary sleeve 28 causes the inclined surface 28a to move relative to the locking pin 34, specifically, when the rotary sleeve 28 is moved clockwise, the locking pin 34 is moved upward in the direction shown by the arrow 48 due to its relationship with the inclined surface 28a. At the same time, since the locking pin 34 is caught in the chute 36b of the intermediate piece 36, in addition to the axial extension direction parallel to the first axis 42, the chute 36b also has a circumferentially extending direction substantially perpendicular to the first axis 42 and along the second axis 50, the chute 36b therefore allows the locking pin 34 to move upward in the direction of the first axis 42 and to move in a direction away from the saw blade 24 in the direction of the second axis 50. In this way, as the locking pin 34 gradually moves to the other end of the chute 36b, that is, the end closest to the transmission rod 20 and away from the rotary sleeve 28, the locking pin 34 no longer contacts the saw blade 24, and releases the clamping of the saw blade 24. The user can then remove the saw blade 24 and replace it with a new one. During this process, the user's one hand must always overcome the resilient spring force of the torsion spring 38 and the strip spring 32 to trigger the handle 28b, otherwise the clamping mechanism will automatically return to the clamped position. If the new saw blade is replaced and is in the clamping mechanism, the user can release the handle 28b, and the clamping mechanism re-clamps the saw blade through the exact opposite process described above.

Therefore, after introducing several embodiments, those skilled in the art can recognize that different modifications, other structures, and equivalents can be used without departing from the essence of the present application. Accordingly, the above description should not be considered as limiting the scope of the application as determined by the following claims.

For example, in the above embodiment, the locking pin is used to clamp the side edge of the saw blade (that is, the edge having only a thickness). However, in other variations, the present application may also be designed to clamp the side surface of the saw blade (that is, the side having the width) with a locking pin.

In addition, the connection between the transmission rod and the intermediate piece in the above embodiment is formed by two screws arranged along the length direction of the transmission rod. Those skilled in the art will understand that in other variations of the present application, the screws may also be arranged in different directions, such as in the width direction of the transmission rod.

It should be noted that the jig saw clamping mechanisms in the above embodiments can lock saw blades of different shapes , which includes T-shank saw blades (such as saw blade 24 shown in FIG. 3) and U-shank saw blades (not shown). These two types of saw blades have in common that no mechanism in the clamping mechanism needs to contact the top surface of the T-shank saw blade or the top surface of the U-shank saw blade. In contrast, the above mentioned locking pin 34 merely abuts the side edge of the T-shank or U-shank saw blades, that is, applies a clamping force along the width direction of the T-shank and U-shank saw blades. This design can not only correspond to T-shank and U-shank saw blades, but also to any other type of saw blades.

1. A jig saw comprising a clamping mechanism for removably clamping a saw blade and a driving mechanism, wherein the clamping mechanism is connected to the driving mechanism, wherein the clamping mechanism comprises an actuating member and a locking member, the actuating member configured to rotate about a first axis, thereby driving the locking member to achieve locking or unlocking of the saw blade; the first axis being not parallel to the thickness direction of the saw blade in the installation position; the actuating member comprising an inclined surface extending in a rotation direction of the actuating member; the inclined surface cooperating with the locking member thereby to drive the locking member when the actuating member rotates.

2. The jig saw according to claim 1, wherein the first axis is substantially parallel to a length direction of the saw blade in the installation position.

3. The jig saw according to claim 2, wherein the clamping mechanism further comprises an intermediate piece; the locking member movably connected to the intermediate piece; the intermediate piece causing the locking member to generate a movement along the first axis and a movement along a second axis at the same time when the actuating member rotates, thereby achieving the locking and unlocking of the saw blade.

4. The jig saw according to claim 3, wherein the second axis is parallel to a width direction of the saw blade in the installation position.

5. The jig saw according to claim 4, wherein e the intermediate piece is a sleeve including a chute; the locking member received within the chute and is adapted to move along the chute; the orientation of the chute being neither parallel to the first axis nor perpendicular to the first axis.

6. The jig saw according to claim 1, wherein the clamping mechanism further comprises a first biasing member adapted to bias the actuating member along the rotation direction so that the clamping mechanism is in a locked position when no external force is applied.

7. The jig saw according to claim 1, wherein the clamping mechanism further comprises a second biasing member adapted to bias the locking member along the first axis direction so that the locking member is in the locked position when no external force is applied.

8. The jig saw according to claim 1, wherein the clamping mechanism is suitable for both a U-shank saw blade and a T-shank saw blade.

9. A jig saw comprising:
a driving mechanism;
a saw blade removably couplable to the driving mechanism, the saw blade having a first axis defined along the length of the saw blade when the saw blade is in an installation position and a second axis defined along the width of the saw blade when the saw blade is in the installation position; and
a clamping mechanism removably coupling the saw blade to the driving mechanism, the clamping mechanism including a locking member and an actuating member, the locking member selectively engagable with the saw blade to lock the saw blade to the driving mechanism, the actuating member rotatable about the first axis and including an inclined surface cooperating with the locking member to disengage the locking member from the saw blade when the actuating member is rotated about the first axis.

10. The jig saw of claim 9, wherein rotation of the actuating member simultaneously drives movement of the locking member along the first axis and the second axis.

11. The jig saw of claim 9, wherein the actuating member further comprises an intermediate piece driving movement of the locking member along the direction of the first axis and driving movement of the locking member along the direction of the second axis.

12. The jig saw of claim 11, wherein the intermediate piece includes a chute receiving the locking member, the locking member being slidable within the chute.

13. The jig saw of claim 12, wherein an orientation of the chute is neither parallel to the first axis nor perpendicular to the first axis.

14. The jig saw of claim 11, wherein the intermediate piece is a sleeve.

15. The jig saw of claim 9, wherein the clamping mechanism further comprises a first biasing member adapted to bias the actuating member along the rotation direction so that the clamping mechanism is in a locked position when no external force is applied.

16. The jig saw of claim 15, wherein the clamping mechanism further comprises a second biasing member adapted to bias the locking member along the first axis direction so that the locking member is in the locked position when no external force is applied.

17. The jig saw of claim 9, wherein the clamping mechanism is suitable for both a U- shank saw blade and a T-shank saw blade.

18. A jig saw comprising:
a driving mechanism;
a saw blade removably couplable to the driving mechanism, the saw blade having a first axis defined along a length of the saw blade when the saw blade is in an installation position and a second axis defined along a width of the saw blade when the saw blade is in the installation position;
a clamping mechanism removably coupling the saw blade to the driving mechanism, the clamping mechanism including
a locking member selectively engagable with the saw blade to lock the saw blade to the driving mechanism,
an actuating member including an inclined surface engaging the locking member, wherein the inclined surface forces the locking member away from the saw blade when the actuating member is rotated about the first axis, and
an intermediate member including a chute receiving the locking member, wherein the locking member is slideable within the chute when the actuating member is rotated about the first axis.

19. The jig saw of claim 18, wherein the locking member is biased towards the saw blade when the saw blade is coupled to the driving mechanism.

20. The jig saw of claim 18, wherein rotation of the actuating member simultaneously drives movement of the locking member along the first axis and the second axis.
